(19) United States
(12) Patent Application Publication
(10) Pub. No.: US 2009/0129994 A1
(43) Pub. Date: May 21, 2009

(54) Large Particle, High Mineral Purity Delaminated Kaolins and Methods of Preparing and Using Same

(75) Inventors: Edward J. Sare, Macon, GA (US); Tommy L. Adkins, Cochran, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Kaolin, Inc., Dry Branch, GA (US)

(21) Appl. No.: 12/282,118

(22) PCT Filed: Mar. 8, 2007
(86) PCT No.: PCT/US07/63558

§ 371 Date: Nov. 12, 2008

Related U.S. Application Data
(60) Provisional application No. 60/780,373, filed on Mar. 9, 2006.

(51) Int. Cl. B01J 29/06; B32B 5/16; B29C 63/00; B01D 53/94; B01J 21/16

(52) U.S. Cl. 422/168; 428/328; 156/344; 428/325; 502/84; 502/68

(57) ABSTRACT

Disclosed herein are compositions comprising novel delaminated kaolins having a large particle size and low levels of alkali metal oxides. Methods of making the disclosed delaminated kaolin by calcining hydrous kaolin are described. Applications using the disclosed compositions in preparing catalyst substrates, paints, coatings, sealants, cementitious products, ceramics, rubbers, polymers and other compositions are also described.

### CLAIM FOR PRIORITY

This application claims priority to U.S. Provisional Patent Application No. 60/780,373 filed on Mar. 9, 2006, which is incorporated herein by reference in its entirety.

### DESCRIPTION OF THE INVENTION

1. Field of the Invention

Disclosed herein are compositions comprising novel delaminated kaolins having a large particle size and low levels of alkali metal containing compounds, such as alkali metal oxides. Methods of making these compositions and their uses are also disclosed.

2. Background of the Invention

Kaolin is a white industrial mineral comprising aluminosilicates, which has found use in a wide range of applications, such as catalyst substrates, paints, paper coating compositions, sealants, cementitious products, ceramics, rubbers, polymers and other compositions. Large deposits of kaolin clay exist in Devon and Cornwall England, Brazil, China, Australia and in the states of Georgia and South Carolina in the United States of America, among other locations.

Particulate kaolins occur naturally in the hydrous form and exist as crystalline structures containing hydroxyl functionality. These hydrous kaolins may contain other mineral components, such as alkali metal containing compounds, e.g., alkali metal oxides. Alkali metal oxides include, but are not limited to, sodium oxide (Na₂O) and potassium oxide (K₂O).

However, the levels of alkali metal oxides present in naturally occurring hydrous kaolin can have a deleterious effect in some applications, such as, for example, in the case of catalyst substrates used in catalytic converters where excess alkali metal contamination can cause at least one of decreasing the number of NO₂ adsorption sites, increasing the coefficient of thermal expansion (where the catalytic converter is a ceramic), and generally weakening the structural properties of the ceramic. Furthermore, the ability of catalyst substrates to effectively function in catalytic converters may depend in part on the particle size of the catalyst substrate. Therefore, a need exists for improved catalyst substrate materials for catalytic converters.

### SUMMARY OF THE INVENTION

Disclosed herein is a composition comprising a delaminated kaolin having a mean particle size (d₅₀) of at least about 2 μm, the delaminated kaolin having an alkali metal oxide content not greater than about 0.17% by weight, relative to the total weight of the delaminated kaolin.

Also disclosed are bodies formed from these compositions, such as green bodies and ceramic bodies, including those used in catalytic applications. Methods of making such compositions by delaminating a coarse kaolin are also disclosed.

### BRIEF DESCRIPTION OF THE DRAWINGS

FIG. 1 is a plot of cumulative mass percent (y-axis) versus equivalent spherical diameter (x-axis) for the coarse feed, an inventive 2 μm sample (sample “C”), an inventive 5 μm sample (sample “I”), a conventionally processed “Trad 2 μm” sample, and a conventional finer particle delaminated kaolin control from Example 1.

FIGS. 2A and 2B are each scanning electron micrographs (SEM) of a conventionally processed kaolin.

FIGS. 3A, 3B, and 3C show scanning electron micrographs (SEM) of the coarse feed (3A), an inventive 5 μm sample (3B) (sample “I”), and an inventive 2 μm sample (3C) (sample “C”) from Example 1.

### DESCRIPTION OF THE EMBODIMENTS

Kaolin predominantly comprises kaolinite crystals, which are shaped as thin hexagonal plates or in booklets of platelets called “stacks.” Kaolinite stacks may be subjected to a grinding action to easily separate or delaminate the stacks or books into smaller books or individual platelets. The act of delamination parts or cleaves natural kaolinite crystals along the (001) crystallographic plane that is perpendicular to its “c-axis.” Accordingly, “delaminated” as used herein refers to kaolin that has been subjected to such separation.

In one embodiment, a delaminated kaolin comprises a kaolin in which a substantial portion of the kaolin is in the form of individual plates.

In one embodiment, the kaolin may be delaminated by comminuting, e.g., grinding or milling (e.g., attrition grinding a dispersed slurry of crude or processed kaolin), of a coarse kaolin to give suitable delamination thereof. The comminution may be carried out by use of beads or granules of a ceramic or plastic, e.g., nylon, grinding or milling aid. Appropriate grinding energies will be readily apparent and easily calculated by the skilled artisan. The kaolin subjected to delaminating may have been previously subjected to at least one process chosen from blunging, degritting, beneficiating, or separating, e.g., by using a coarse-particle size fraction from a centrifuge.

In one embodiment, the content of alkali metal oxides can be determined as a percentage by weight, relative to the total weight of the delaminated kaolin. The content can be determined by, e.g., X-ray fluorescence spectroscopy using a Bruker SRS 3000 X-Ray Fluorescence Spectrometer.

In one embodiment, the delaminated kaolin has an alkali metal content of not greater than about 0.16% by weight, such as an alkali metal content not greater than about 0.15% by weight, relative to the total weight of the delaminated kaolin.

In one embodiment, the delaminated kaolin has a K₂O content not greater than about 0.1% by weight, such as a K₂O content not greater than about 0.095% by weight, relative to the total weight of the delaminated kaolin. In another embodiment, the delaminated kaolin has a Na₂O content not greater than about 0.5% by weight, relative to the total weight of the delaminated kaolin.

In one embodiment, the phrase “having a mean particle size (d₅₀) of at least about 2 μm” refers to a d₅₀ as determined using a SEDIGRAPH 5100 instrument as supplied by Micromeritics Corporation, unless another method of particle size determination is specified. In one embodiment, particle sizes, and other particle size properties referred to in the present disclosure, are determined using Sedigraph. The size of a given particle is expressed in terms of the diameter of a sphere of equivalent diameter, which sediments through the suspension, i.e., an equivalent spherical diameter or esd. The mean particle size, or the d₅₀ value, is the value of the particle esd at which there are 50% by weight of the particles, which have an esd less than that d₅₀ value.

All particle size data measured, determined and reported herein, including in the examples, were taken in a known manner, with measurements made in water at the standard temperature of 34.9° C. All percentages and amounts expressed herein are by weight. All amounts, percentages, and ranges expressed herein are approximate.

In one embodiment, the d₅₀ of the delaminated kaolin is at least about 3 μm, at least about 4 μm, at least about 5 μm, at least about 10 μm, at least about 15 μm, or at least about 20 μm.

In one embodiment, the delaminated kaolin has a coarser particle size distribution than other kaolins having a similar mean particle size. In one embodiment, the delaminated kaolin has a particle size distribution such that less than about 20% of the kaolin has a particle size less than about 0.5 μm, or less than about 15% of the kaolin has a particle size less than about 0.5 μm, or even less than about 10% of the kaolin has a particle size less than about 0.5 μm.

In another embodiment, the delaminated kaolin has a particle size distribution such that less than about 55% of the kaolin has a particle size less than about 2 μm, or less than about 50% of the kaolin has a particle size less than about 2 μm, or less than about 40% of the kaolin has a particle size less than about 2 μm, or even less than about 30% of the kaolin has a particle size less than about 2 μm.

In one embodiment, delaminating increases the shape factor of the kaolin clay. “Shape factor” as used herein is a measure of an average value (on a weight average basis) of the ratio of mean particle diameter to particle thickness for a population of particles of varying size and shape as measured using the electrical conductivity method and apparatus described in column 1, line 6 through column 7, line 43 of U.S. Pat. No. 5,576,617, which is incorporated herein by reference, and using the equations derived therein.

In one embodiment, the delaminated kaolin has a shape factor at least about 20, such as a shape factor of at least about 30, at least about 45, at least about 50, or at least about 60.

In one embodiment, the delaminated kaolin has a BET surface area of less than about 10 m²/g, such as a BET surface area of less than about 9 m²/g, or a BET surface area of less than about 8 m²/g.

Significant grinding energies may be necessary to attain desirable high shape factors. It is understood, however, that kaolin crude selected for its natural platyness may grind to high shape factors in an energy range typically used to manufacture standard delaminated kaolin pigments that have lesser shape factors.

Another embodiment of the present disclosure provides a method of preparing a composition comprising:
delaminating a feed kaolin having an alkali metal oxide content not greater than about 0.17% by weight, to form a delaminated kaolin having a mean particle size (d₅₀) of at least about 2 μm.

The coarse kaolin can be delaminated by e.g., grinding or milling (e.g., attrition grinding a dispersed slurry of crude or processed kaolin), of the coarse kaolin to give suitable delamination thereof, as described herein.

Delaminated kaolins having a coarse particle size can be useful in paint compositions. Accordingly, another aspect of the present disclosure provides a paint composition comprising any of the delaminated kaolin compositions described herein. In one embodiment, the paint comprises a composition comprising a delaminated kaolin having a mean particle size (d₅₀) of at least about 2 μm, the delaminated kaolin having an alkali metal content of not greater than about 0.17% by weight, relative to the total weight of the delaminated kaolin. In another embodiment, the paint can further comprise at least one thickener present in an amount effective to stabilize the paint. In one embodiment, the amount of thickener ranges from about 1 pound to about 10 pounds thickener per 100 gallons of paint.

Paint compositions comprising delaminated kaolin and optionally at least one ingredient chosen from thickeners, dispersants, and biocides, as described herein, may additionally comprise at least one additional ingredient chosen from a polymeric binder, a primary pigment such as titanium dioxide, a secondary pigment such as calcium carbonate, silica, nephaline syenite, feldspar, dolomite, diatomaceous earth, and flux-calcined diatomaceous earth. For water-based versions of such paint compositions, any water-dispersible binder, such as polyvinyl alcohol (PVA) and acrylics may be used. Paint compositions of the present invention may also comprise other conventional additives, including, but not limited to, surfactants, thickeners, defoamers, wetting agents, dispersants, solvents, and coalescents.

As opacifiers, delaminated kaolins impart brightness, whiteness, and other desirable optical properties. As extenders, they allow partial replacement of titanium dioxide and other more expensive pigments with minimal loss of whiteness or opacity. For example, increased opacity in high PVC paints comprising delaminated kaolins can be the result of greater resin demand. The extender material can be used in paper, polymers, paints and the like or as a coating pigment or color ingredient for coating of paper, paper board, plastic papers and the like.

The delaminated kaolin products of the present disclosure can be used in coating compositions in which any one of these characteristics are desired. In one embodiment, the delaminated kaolin is a component of a paper coating. Products comprising the disclosed delaminated kaolin compositions may also be useful wherever kaolins are used, such as in making filled plastics, rubbers, sealants, cables, ceramic products, cementitious products, and paper products and paper coatings.

The composition according to the present disclosure can be used in the production of all paper grades, from ultra lightweight coated paper to coated or filled board. Paper and paperboard products can comprise a coating, which can improve the brightness and opacity of the finished paper or board.

Paper coatings according to the present disclosure can include, in addition to the delaminated kaolin as described above, materials generally used in the production of paper coatings and paper fillers. The compositions can include a binder and a pigment, such as TiO₂. The coatings according to the present disclosure may optionally include other additives, including, but not limited to, dispersants, cross-linkers, water retention aids, viscosity modifiers or thickeners, lubricity or calendering aids, antifoamers/defoamers, gloss-ink hold-out additives, dry or wet rub improvement or abrasion resistance additives, dry or wet pick improvement additives, optical brightening agents or fluorescent whitening agents, dyes, biocides, leveling or evening aids, grease or oil resistance additives, water resistance additives and/or insolubilizers.

Any art recognized binder may be used in the present compositions. Exemplary binders include, but are not limited to, adhesives derived from natural starch obtained from a known plant source, for example, wheat, maize, potato or tapioca; synthetic binders, including styrene butadiene, acrylic latex, vinyl acetate latex, or styrene acrylic; casein; polyvinyl alcohol; polyvinyl acetate; or mixtures thereof.

Paper coatings have very different binder levels depending upon the type of printing to be used with the coated paper product. Appropriate binder levels based upon the desired end product would be readily apparent to the skilled artisan. Binder levels are controlled to allow the surfaces to receive ink without disruption. The latex binder levels for paper coatings generally range from about 3% to about 30%. In one embodiment, the binder is present in the paper coating in an amount ranging from about 3% to about 10%. In another embodiment, the binder is present in the coating in an amount ranging from about 10% to about 30% by weight.

One embodiment of the present disclosure provides a polymer comprising a composition comprising a delaminated kaolin having a mean particle size (d₅₀) of at least about 2 μm, the calcined kaolin having an alkali metal oxide content not greater than about 0.17% by weight, relative to the total weight of the delaminated kaolin. The delaminated kaolin disclosed herein can be used for resin extension (i.e., filling), TiO₂ extension, and reinforcement of the polymer. In one embodiment, the polymer product can be a highly filled polymer such as a cultured marble. In another embodiment, the polymer product can be a plastic. In a further embodiment, the polymer may be a polymer film. In yet another embodiment, the polymer product can be an adhesive, caulk or sealant. The disclosed polymer product may be useful in reducing surface gloss and as an antiblock to prevent sticking.

The polymer product disclosed herein comprises at least one polymer resin. The term “resin” means a polymeric material, either solid or liquid, prior to shaping into a plastic article. The at least one polymer resin can be one which, on cooling (in the case of thermoplastic plastics) or curing (in the case of thermosetting plastics), can form a plastic material. The at least one polymer resin, which can be used herein, can be chosen, for example, from polyolefin resins, polyamide resins, polyester resins, engineering polymers, allyl resins, thermoplastic resins, and thermoset resins.

In another embodiment, the present disclosure provides a rubber product comprising a composition comprising a delaminated kaolin having a mean particle size (d₅₀) of at least about 2 μm, the delaminated kaolin having an alkali metal oxide content not greater than about 0.17% by weight, relative to the total weight of the delaminated kaolin. The delaminated kaolin can provide the benefits of resin extension, reinforcement of the rubber, and increased hardness of the rubber composition. The rubber product disclosed herein comprises at least one rubber chosen from natural rubbers and synthetic rubbers.

One embodiment of the present disclosure provides a method of forming a ceramic body, comprising:
(a) combining a delaminated kaolin with water and at least one compound selected from alumina, talc and aluminum hydroxide to form a clay comprising the delaminated kaolin, wherein the delaminated kaolin has a mean particle size (d₅₀) of at least about 2 μm, the delaminated kaolin having an alkali metal oxide content not greater than about 0.17% by weight, relative to the total weight of the delaminated kaolin, and
(b) extruding the clay to form the ceramic body.

In one embodiment, the delaminated kaolin is combined with alumina, talc and aluminum oxide. In another embodiment, at least one component selected from a binder and a lubricant is added prior to adding the amount of water. Suitable binders include those listed above. An art recognized lubricant may also be used in the disclosed method. The amount of water to be added can be determined by the skilled artisan to arrive at a clay with desired properties, such as a desired viscosity. Mixing may be accomplished by a kneading machine, for example. Extruding the clay may involve the use of an art-recognized molding machine. The form of the extruded ceramic body may be, for example, a rod or a cellular shape.

In one embodiment, the extruding comprises a forming method commonly used in the production of complex ceramic objects, such as intricate honeycomb ceramics used as substrate supports in catalytic converters. One skilled in the art will recognize that extrusion may be carried out in a number of different ways, such as, for example, the methods disclosed in U.S. Pat. No. 3,885,977 to Lachman, U.S. Pat. No. 5,332,703 to Hickman et al., or U.S. Pat. No. 5,997,984 to Koike et al., the disclosures related to such methods are herein incorporated by reference.

In one embodiment, the extruded ceramic body has a honeycomb structure. In a further embodiment, the extruded ceramic body is a catalyst substrate. In another embodiment, a composition comprising a delaminated kaolin as disclosed herein is used to form cordierite, a magnesium alumina silicate. Cordierite is known for properties such as a low coefficient of thermal expansion, high thermal shock resistance, volume resistivity, and good electrical insulation properties. Another embodiment provides a catalyst substrate comprising the cordierite. In addition to catalyst substrates, the cordierite may be used in manufacturing kiln furniture, among other products, due to its thermal shock resistance.

Catalytic converters using the disclosed catalyst substrates may be used for modifying the emissions from fossil fuel based power sources, including, but not limited to, gasoline engines and diesel engines. The large mean particle size of the disclosed delaminated kaolin may be useful in the larger catalyst substrates employed in catalytic converters for diesel engines. The low level of alkali metal oxides may increase the performance of catalyst substrates comprising the disclosed delaminated kaolin. Even small amounts of alkali metal oxides may lead to undesirable properties in conventional catalyst substrates, such as decreasing the number of NO₂ adsorption sites, increasing the coefficient of thermal expansion and generally weakening the structural properties of the ceramic.

Another embodiment of the present disclosure provides a method of forming a ceramic body, comprising:
(a) adding a liquid medium to a composition comprising a delaminated kaolin having a mean particle size (d₅₀) of at least about 2 μm, the delaminated kaolin having an alkali metal oxide content not greater than about 0.17% by weight, relative to the total weight of the delaminated kaolin, to form a delaminated kaolin slurry;
(b) flocculating the delaminated kaolin slurry;
(c) dewatering the delaminated kaolin slurry to obtain a delaminated kaolin wet cake; and
(d) forming the delaminated kaolin wet cake into a ceramic body.

In one embodiment, the delaminated kaolin slurry in (a) further comprises at least one mineral chosen from hydrous kaolin, talc, halloysite, calcium carbonate, gypsum, feldspar, silica, and nepheline syenite. In another embodiment, the method of forming the slurry further comprises adding a biocide to the delaminated kaolin slurry.

The delaminated kaolin slurry may also be screened by blunging the delaminated kaolin in water to form an aqueous suspension. In one embodiment, the slurry further comprises at least one dispersant. The at least one dispersant can be present in an amount effective to fluidize the slurry, for example in an amount ranging from about 0.01% to about 2% by weight, relative to the total weight of the slurry, such as an amount ranging from about 0.01% to about 1% by weight.

In one embodiment, at dispersing agent is added to the slurry before flocculation, resulting in a pH that is greater than or equal to about 6.5, such as a pH ranging from about 8 to about 10. To achieve the desired pH, the slurry can further comprise at least one water-soluble pH modifier. Non-limiting examples of suitable pH-modifiers include sodium carbonate, ammonium carbonate, amino-2-methyl-1-propanol, sodium silicate, sodium hydroxide, and ammonium hydroxide. In some embodiments, the non-alkali metal salts may be selected to reduce the overall alkali metal content of the product.

Dispersing agents may also be chosen from art recognized organic polymeric dispersants that are traditionally used in kaolin-containing compositions. Appropriate dispersants will be readily apparent to the skilled artisan. For example, dispersants may be chosen from polyelectrolytes such as polyacrylates and copolymers comprising polyacrylate species, for example polyacrylate salts (such as sodium, ammonium and potassium salts), sodium hexametaphosphates, polyphosphoric acid, condensed sodium phosphate, alkanolamines, and other reagents commonly used for this function. Other non-limiting examples of suitable dispersants include 2-amino-2-methyl-1-propanol, tetrasodium pyrophosphate, trisodium phosphate, tetrasodium phosphate, sodium tripolyphosphate, sodium silicate, sodium carbonate, sodium or potassium salts of weak acids, such as condensed naphthalene sulfonic acid and polymeric carboxylic acid, and water-soluble organic polymeric salts, such as sodium or ammonium polyacrylate, and polymethacrylates such as sodium or ammonium polymethacrylate.

The fluid delaminated kaolin slurry may then flocculated in (b), typically by lowering the pH of the fluid delaminated kaolin slurry to less than or equal to about 5, such as less than or equal to about 4. This downward pH adjustment can be accomplished by simply adding an appropriate amount of an acid, such as for example sulfuric acid, alum or other suitable acid.

In one embodiment, the flocced delaminated kaolin slurry may be dewatered in (c) by one of the ways well known in the art, e.g., filtration such as via rotary filter or filter press, centrifugation, evaporation and the like, provided that the slurry has a moisture content of greater than or equal to about 10%, such as about 15% or about 20%, at all points between the flocculating and forming processes. Dewatering can also be accomplished with a filter press.

In one embodiment, the forming in (d) comprises at least one method chosen from casting, rolling, extruding, pressing, and molding the delaminated kaolin.

In one embodiment, the method allows formation of cast ceramic ware product comprising the ceramic body, or formation of an extruded ceramic body comprising the ceramic body. Even further disclosed herein are ceramic body filter cakes, greenware products, and catalyst substrates comprising the ceramic bodies as described herein.

Slip casting is typically used in production of products having complex shapes and where plastic forming or semi-dry pressing are not possible. Thus, slip casting is applicable to the production of, for example, hollow tableware, figures and ornamental ware, and sanitary ware. For whiteware production, ‘jiggering’ can also be used to produce ware. Slip casting involves the use of a mold of appropriate shape into which a fluid suspension of a ceramic body can be poured and wherein the mold progressively extracts some of the water until a solid layer is formed.

Two primary methods are typically employed for slip casting: drain casting and solid casting. In drain casting, a mold is filled with slip and casting takes place on one surface only. After a suitable time, during which the desired cast thickness is built up, the excess slip is poured off. The mold and cast are then partially dried to allow mold release, after which the cast can be trimmed, cut or sponged. In solid casting, which is typically used for products having varying wall thicknesses, the mold is filled with slip and casting takes place on both surfaces. The removal of water generally means that the slip has to be topped up during the casting. For complex shapes, the mold can be constructed in several sections.

In one embodiment, the forming in (d) comprises slip casting a delaminated kaolin into a ceramic body. The disclosed delaminated kaolin may serve as a useful component in casting slips due to the low proportion of small particles, e.g., particles with a d₅₀ less than 2 μm.

The present disclosure is further illustrated by the following non-limiting examples, which are intended to be purely exemplary of the disclosure.

### EXAMPLES

### Example 1

This Example compares the properties of inventive large particle size delaminated kaolins versus the properties of conventional finer particle size delaminated kaolin control (“Control”) having a median particle size of approximately 0.6 microns.

The inventive samples were prepared by delaminating a coarse kaolin feed having a median particle size diameter of 7.47 μm. Eight samples (Samples B through I) were ground in a custom made continuous flow grinder having a diameter of 14 inches and a capacity of 14 gallons. For samples B, C, D, and E, the grinder was loaded with 7 gallons of sand and 7 gallons of coarse feed slurry having a solids content of approximately 32% by weight. For samples F, G, H, and I, the grinder was loaded with 7 gallons of sand and 3.5 gallons of coarse feed slurry having a solids content of approximately 32% by weight. In each case, the slurry was then added and removed from the grinder at the noted flow rate, while operating the grinder at 500 rpm.

Table I, below, lists particle size distribution data, 325 mesh residue content, BET surface area, and Na₂O and K₂O impurity data for the coarse feed (“Sample A”), Samples B through I, and the conventional finer particle size delaminated kaolin (“Control”).

TABLE I

| | | Grinder Charge | | | | | | | | |
|---|---|---|---|---|---|---|---|---|---|---|
| | | ½ | ½ | ½ | ½ | Full | Full | Full | Full | |
| | Sample | | | | | | | | | |
| | A | I | H | G | F | E | D | C | B | Control |
| ml/min | 0 | 4000 | 2660 | 2000 | 1200 | 4000 | 2660 | 2000 | 1200 | N/A |
| BRT | 75.1 | 77.2 | 77.8 | 78 | 78.7 | 78.6 | 78.6 | 79.2 | 79.7 | 84.9 |
| % < 10 micron | 74.2 | 89.3 | 91.5 | 92.7 | 93.9 | 94.9 | 95.9 | 96.3 | 98.3 | 98.5 |
| % < 5 micron | 36.5 | 57.1 | 62.4 | 66.3 | 71.1 | 74.4 | 78.1 | 83.3 | 87.6 | 95.6 |
| % < 2 micron | 13.3 | 20.7 | 24.5 | 27.8 | 32.0 | 37.6 | 40.7 | 49.8 | 55.2 | 82.6 |
| % < 1 micron | 6.9 | 10.7 | 12.1 | 14.1 | 16.5 | 19.9 | 21.4 | 28.3 | 32.0 | 65.9 |
| % < 0.5 micron | 3.6 | 5.6 | 5.4 | 5.8 | 6.9 | 8.0 | 7.6 | 10.6 | 12.2 | 44.8 |
| Median | 7.47 | 4.47 | 4.1 | 3.84 | 3.16 | 2.8 | 2.56 | 2.05 | 1.73 | 0.6 |
| Surface Area | 6.7 | 7.5 | 7.8 | 8.2 | 8.6 | 8.3 | 9 | 9.7 | 10.4 | 17.3 |
| % Total K₂O | 0.100 | 0.095 | 0.102 | 0.100 | 0.097 | 0.102 | 0.107 | 0.104 | 0.094 | 0.040 |
| % Total Na₂O | 0.037 | 0.048 | 0.040 | 0.040 | 0.045 | 0.045 | 0.045 | 0.050 | 0.054 | 0.01 |
| Shape Factor | 5.2 | 13.9 | 17 | 21.1 | 30.4 | 36.2 | 44.6 | 50.4 | 59.3 | — |
| RGT* | 1 | 7 | 11 | 13 | 21 | 7 | 11 | 13 | 21 | 1 |

*RGT = relative grinder time

From Table I, it can be seen that the inventive Samples F-I, subjected to a grinder charge of ½, had a median particle size diameter ranging from about 3.16 μm to about 4.47 μm. Inventive Samples B-E showed a median particle size diameter ranging from about 1.73 μm to about 2.8 μm. All of the delaminated inventive samples had a median particle size larger than that of the conventional finer delaminated kaolin control (0.57 μm). In addition, all of the inventive samples had a shape factor greater than commercially available kaolin. Moreover, each of the inventive samples had a total alkali content not greater than about 0.16% by weight with relative to the total weight of the kaolin.

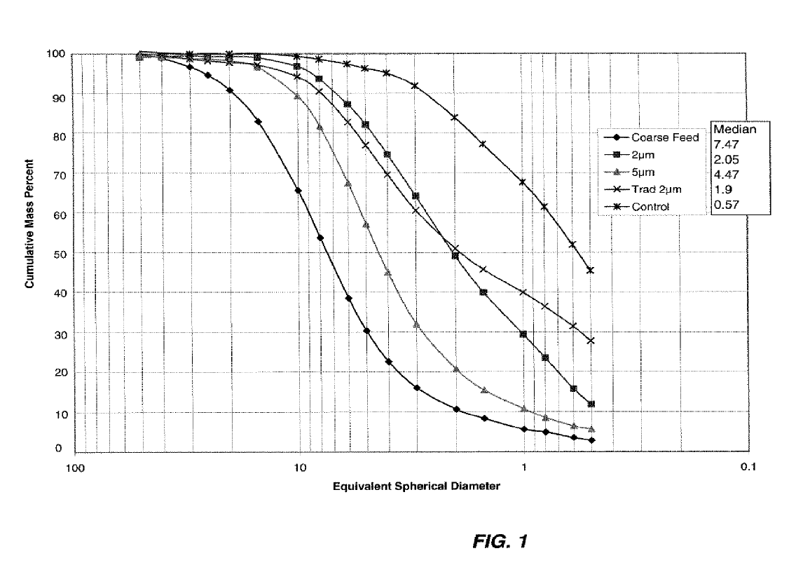

FIG. 1 is a plot of cumulative mass percent (y-axis) versus equivalent spherical diameter (x-axis) for the coarse feed, an inventive 2 μm sample (sample “C”), an inventive 5 μm sample (sample “I”), a conventionally processed “Trad 2 μm” sample, and a commercially available kaolin. From FIG. 1, it can be seen that the inventive samples exhibit a steeper particle size distribution than any of the coarse feed, the commercially available kaolin, or the conventionally processed kaolin.

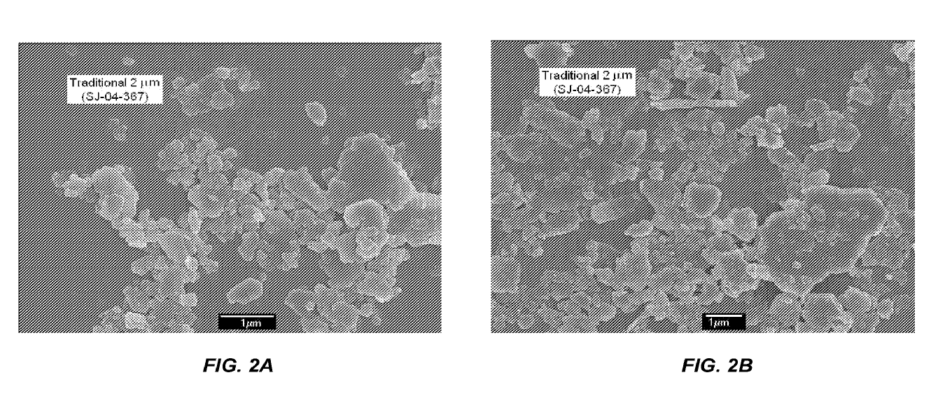

FIGS. 2A and 2B are each scanning electron micrographs (SEM) of conventionally processed kaolin.

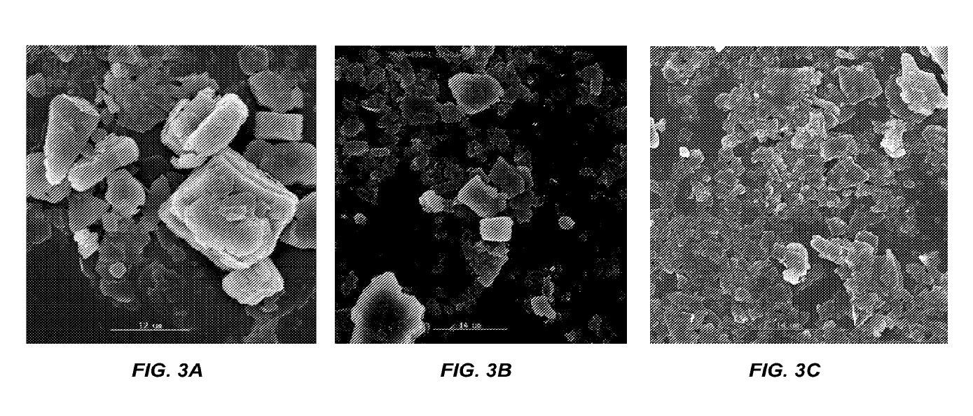

FIGS. 3A, 3B, and 3C show scanning electron micrographs (SEM) of the coarse feed (3A), an inventive 5 μm sample (3B) (sample “I”), and an inventive 2 μm sample (3C) (sample “C”). It can be seen from the SEMs that the inventive kaolin particles provide a less blocky (more delaminated) shape and a more uniform particle size distribution.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure.

Other embodiments of the disclosure will be apparent to those skilled in the art from consideration of the specification and practice of the embodiments disclosed herein. It is intended that the specification and examples be considered as exemplary only, with a true scope and spirit of the disclosure being indicated by the following claims.

What is claimed is:

1. A composition comprising a delaminated kaolin having a mean particle size (d₅₀) at least about 2 μm, the delaminated kaolin having an alkali metal oxide content not greater than about 0.17% by weight, relative to the total weight of the delaminated kaolin.

2. The composition according to claim 1, wherein the alkali metal oxide content is not greater than about 0.16% by weight, relative to the total weight of the delaminated kaolin.

3. The composition according to claim 1, wherein the alkali metal oxide content is not greater than about 0.15% by weight, relative to the total weight of the delaminated kaolin.

4. The composition according to claim 1, wherein the alkali metal oxide is chosen from Na₂O and K₂O.

5. The composition according to claim 4, wherein the K₂O content is not greater than about 0.1% by weight, relative to the total weight of the delaminated kaolin.

6. The composition according to claim 4, wherein the K₂O content is not greater than about 0.095% by weight, relative to the total weight of the delaminated kaolin.

7. The composition according to claim 4, wherein the Na₂O content is not greater than about 0.5% by weight, relative to the total weight of the delaminated kaolin.

8. The composition according to claim 1, wherein the delaminated kaolin has a shape factor of at least about 20.

9. The composition according to claim 1, wherein the delaminated kaolin has a shape factor of at least about 30.

10. The composition according to claim 1, wherein the delaminated kaolin has a shape factor of at least about 45.

11. The composition according to claim 1, wherein the delaminated kaolin has a shape factor of at least about 50.

12. The composition according to claim 1, wherein the delaminated kaolin has a shape factor of at least about 60.

13. The composition according to claim 1, wherein the delaminated kaolin has a BET surface area of less than about 10 m²/g.

14. The composition according to claim 1, wherein the delaminated kaolin has a BET surface area of less than about 9 m²/g.

15. The composition according to claim 1, wherein the delaminated kaolin has a BET surface area of less than about 8 m²/g.

16. The composition according to claim 1, wherein the delaminated kaolin has a particle size distribution such that less than about 20% of the kaolin has a particle size less than about 0.5 μm.

17. The composition according to claim 1, wherein the delaminated kaolin has a particle size distribution such that less than about 15% of the kaolin has a particle size less than about 0.5 μm.

18. The composition according to claim 1, wherein the delaminated kaolin has a particle size distribution such that less than about 10% of the kaolin has a particle size less than about 0.5 μm.

19. The composition according to claim 1, wherein the delaminated kaolin has a particle size distribution such that less than about 55% of the kaolin has a particle size less than about 2 μm.

20. The composition according to claim 1, wherein the delaminated kaolin has a particle size distribution such that less than about 50% of the kaolin has a particle size less than about 2 μm.

21. The composition according to claim 1, wherein the delaminated kaolin has a particle size distribution such that less than about 40% of the kaolin has a particle size less than about 2 μm.

22. The composition according to claim 1, wherein the delaminated kaolin has a particle size distribution such that less than about 30% of the kaolin has a particle size less than about 2 μm.

23. The composition according to claim 1, wherein the mean particle size is at least about 3 μm.

24. The composition according to claim 1, wherein the mean particle size is at least about 4 μm.

25. The composition according to claim 1, wherein the mean particle size is at least about 5 μm.

26. The composition according to claim 1, wherein the mean particle size is at least about 10 μm.

27. The composition according to claim 1, wherein the mean particle size is at least about 15 μm.

28. The composition according to claim 1, wherein the mean particle size is at least about 20 μm.

29. The composition according to claim 1, wherein the delaminated kaolin has a Fe₂O₃ content less than about 1% by weight, relative to the total weight of the delaminated kaolin.

30. The composition according to claim 29, wherein the Fe₂O₃ content is less than about 0.5% by weight, relative to the total weight of the delaminated kaolin.

31. The composition according to claim 1, wherein the delaminated kaolin has a TiO₂ content less than about 2% by weight, relative to the total weight of the delaminated kaolin.

32. The composition according to claim 31, wherein the TiO₂ content is less than about 1% by weight, relative to the total weight of the delaminated kaolin.

33. The composition according to claim 1, wherein an amount of residue in the delaminated kaolin that is retained by a 325 mesh screen is less than about 1% by weight, relative to the total weight of the delaminated kaolin.

34. The composition according to claim 33, wherein the amount of residue is less than about 0.6% by weight, relative to the total weight of the delaminated kaolin.

35. The composition according to claim 34, wherein the amount of residue is less than about 0.1% by weight, relative to the total weight of the delaminated kaolin.

36. The composition according to claim 35, wherein the amount of residue is less than about 0.05% by weight, relative to the total weight of the delaminated kaolin.

37. The composition according to claim 1, wherein the delaminated kaolin has an oil absorption of at least about 40% by weight, relative to the total weight of the delaminated kaolin.

38. The composition according to claim 37, wherein the oil absorption of at least about 50% by weight, relative to the total weight of the delaminated kaolin.

39. The composition according to claim 38, wherein the oil absorption is at least about 60% by weight, relative to the total weight of the delaminated kaolin.

40. The composition according to claim 39, wherein the oil absorption is at least about 70% by weight, relative to the total weight of the delaminated kaolin.

41. The composition according to claim 1, wherein the composition has a GE brightness of at least about 70%.

42. The composition according to claim 41, wherein the GE brightness is at least about 80%.

43. A green body comprising a delaminated kaolin having a mean particle size (d₅₀) about 2 μm, the delaminated kaolin having an alkali metal oxide content of not greater than about 0.17% by weight, relative to the total weight of the delaminated kaolin.

44. A ceramic body comprising a delaminated kaolin having a mean particle size (d₅₀) about 2 μm, the delaminated kaolin having an alkali metal oxide content of not greater than about 0.17% by weight, relative to the total weight of the delaminated kaolin.

45. A catalyst substrate comprising a composition, said composition comprising a delaminated kaolin having a mean particle size (d₅₀) of at least about 2 μm, and the delaminated kaolin having an alkali metal oxide content not greater than about 0.17% by weight, relative to the total weight of the delaminated kaolin.

46. The catalyst substrate of claim 45, wherein the composition further comprises cordierite.

47. The catalyst substrate of claim 45, which is a catalytic converter for a fossil fuel based power source chosen from a gasoline engine, or a diesel engine.

48. A method of preparing a composition comprising:
delaminating a feed having an alkali metal oxide content not greater than about 0.17% by weight, to form a delaminated kaolin having a mean particle size (d₅₀) of at least about 2 μm.
